(19) United States
(12) Patent Application Publication
(10) Pub. No.: US 2004/0194875 A1
(43) Pub. Date: Oct. 7, 2004

(54) Bonding type accessory

(76) Inventor: Mi-young Lee, Seoul (KR)

Correspondence Address: BIRCH STEWART KOLASCH & BIRCH, PO BOX 747, FALLS CHURCH, VA, 22040-0747, US

(21) Appl. No.: 10/480,894

(22) PCT Filed: Dec. 16, 2002
(86) PCT No.: PCT/KR02/02363

(30) Foreign Application Priority Data
Apr. 15, 2002 (KR) 20-2002-0011277

(51) Int. Cl. B44C 1/00; B32B 3/00

(52) U.S. Cl. 156/230; 428/195.1

(57) ABSTRACT

This invention is about adhesion type accessories, which are usable at part of body or clothes by adhering, and which were various types and have volume and aesthetic sense, the above invention is made of forming adhesion layer at a part of soft bottom layer with a certain type, and the other part of above bottom layer is made of one or more than two among resin materials in a micro size, metal, stone, spangle, glass, textiles with a certain type and feather.

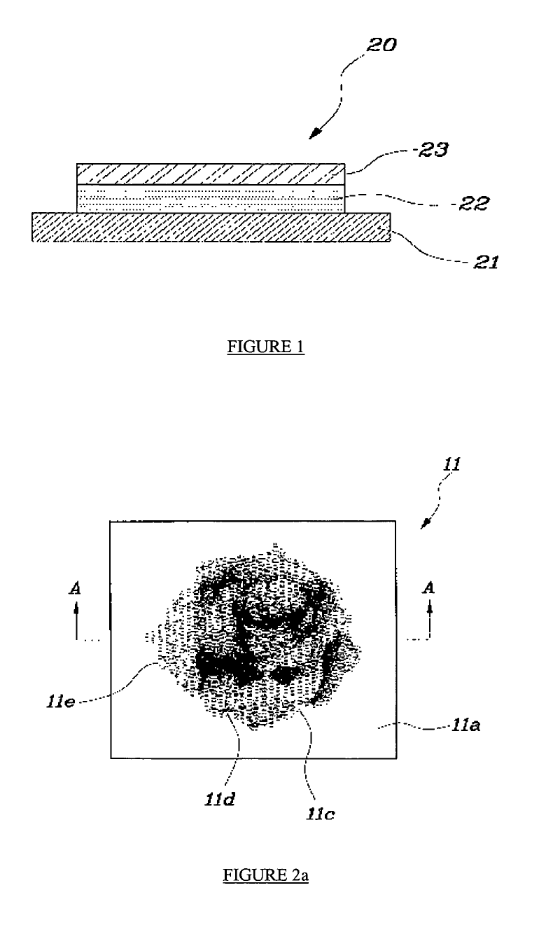

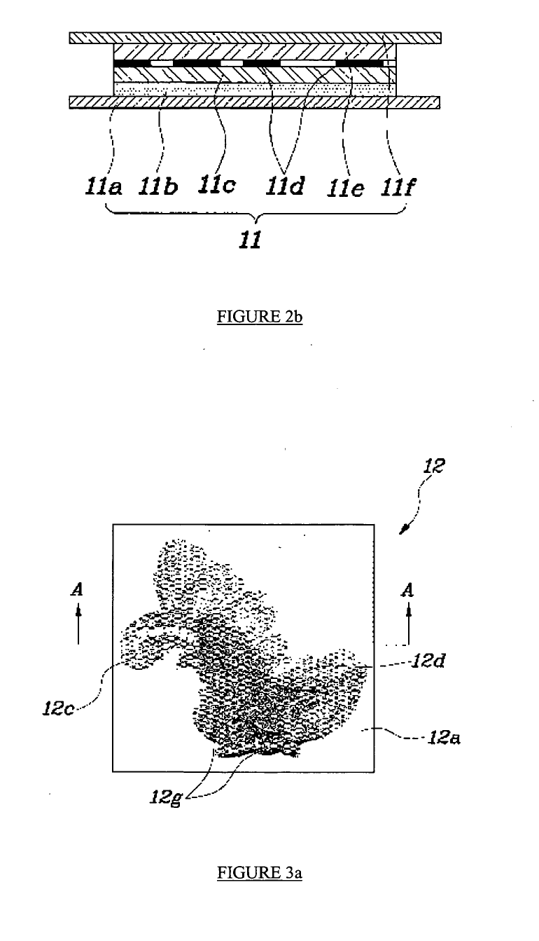

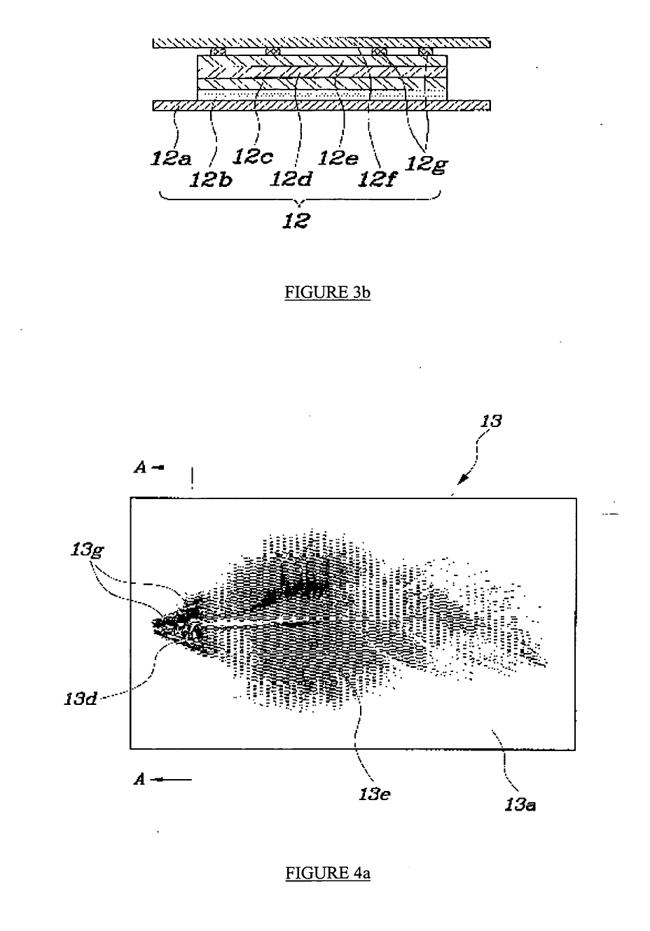

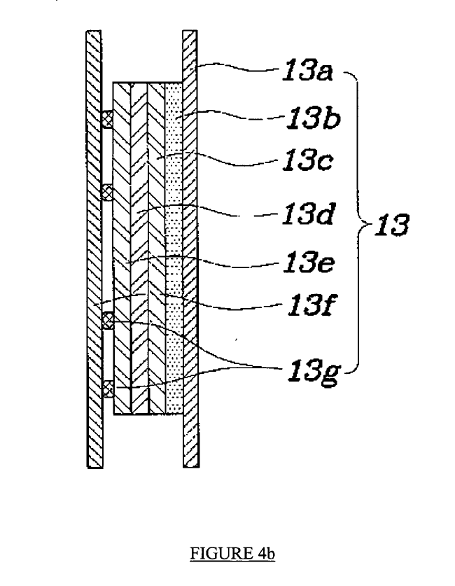

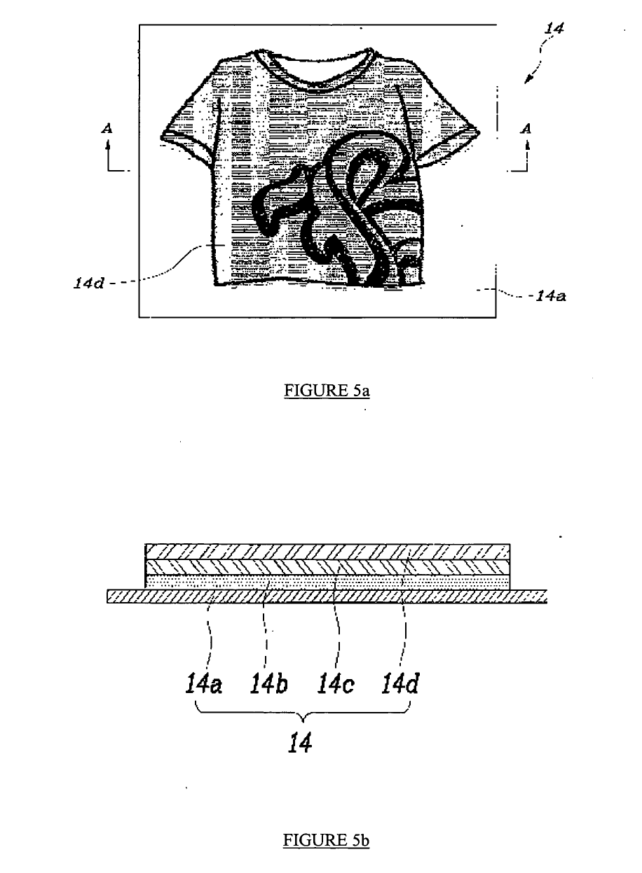

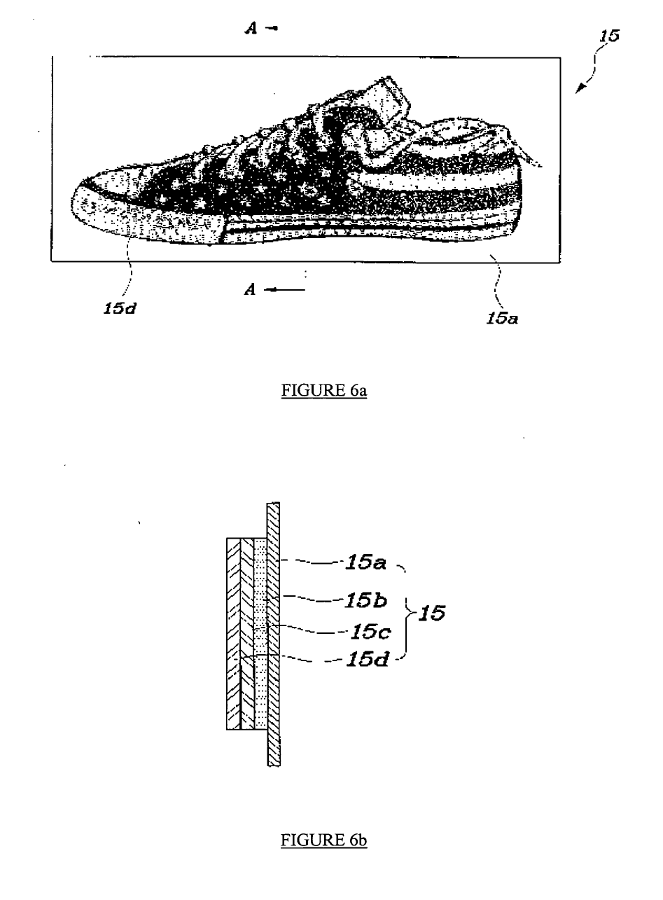

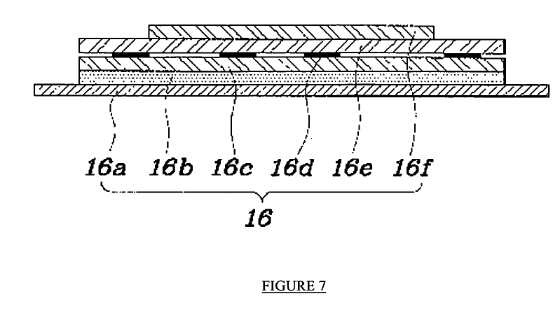

### TECHNICAL FIELD

This invention is about bonding type accessory, in detail, the above invention is to make bonding layer on the part of the bottom layer of the softy material, and is to bond accessory made by one or more than two of the manufactured resin in a micro size, metal, stone, spangle, glass, a type of textiles, feather on the other part of the bottom layer, and those things are bonded for accessory effect on a certain part of the body or cloths, glass, any places.

### BACKGROUND ART

In general, the ornaments to use for the ornament effect on a part of the body, on a certain part of the cloth, on the designated place, on the glass are made by printing words, pictures on one part of the resin film and bonding ornament with bonding material on the surface of the transcription material and then pressing or heat-pressing the above printed words, pictures on the resin.

And the above ornament form the printing layer by words, word types made of the eraser, the pvc on the surface of the different type paper of the resin, and form the Hot meltadhesive on the upper part of the printing layer. The eraser transcription forming the above printing layer made of eraser is to melt the composition eraser by a solvent and print on the different type paper, so the eraser is heat plasticity materials and the printing layer is made thin during pressing and it is not possible to heat after transcribing on the textile. In addition, there is a problem causing occupational diseases that hurt the health of the workers and environmental pollution based on using lots of volatile solvent and there is another problem of corroding easily by the soap, the ultraviolet rays on a state of transcribing on the cloth. In the other hand, the transcribing by heating and pressing is impossible since the pvc has heat melting property in case that the above printing layer is pvc material, and since it has a solid property in a state of solidity, the surface of it is rough and it is easily detached at the state of transcribing on the cloth and it has a problem of coarse by corrosion and decolorization in case of exposure for a long time. In present, to solve the problem of the materials of the eraser, the pvc as above materials, the polysiloc acid, silicon, which is a strong point in the heat-resistant, the water-resistant, the medicine-resistant, the infirmity-resistant, the poison-resistant, the insulation property, is used for making ornament label after designing word, design on the cloth. However, it is not possible to print on the transcribing materials of the cloth by transcribing method since the silicon doesn't have bonding property. So, the method of making the ornament label is the following; add the solvent to the above silicon, and mix it with water and alcohol until a state of kneading, and make a certain type by putting it in a frame, and pad the texture on the frame and bond and solidity it by heating and pressuring, after then, separate texture from the frame. But this ornament label has not volume and diversity since the materials that can be heated and pressured to the silicon are a few like textures.

### DISCLOSURE OF INVENTION

This invention is to solve the above problem; the goal of the invention is to provide bonding type accessory by making it easily and having high quality of volume and esthetic sense and several types of the ornaments and bonding them on the designated spot of the clothes.

To get the above goals, the characteristic compositions of the invention are to make bonding layer on a part of the softy bottom of a certain type and bond ornament which is made by mixing one or more than two among resin, metal, stone material, spangle, glass, a certain type of textures, feather, and these things were made in a micro size on the other part of the above bottom layer.

And, flower, tree, vegetation, animal, star map, certain types are transcribed on the other softy bottom layer, where the above ornament is bonded as the bottom drawing, and the different type paper is bonded on the bonding layer made on a part of the softy bottom layer, another different ornament bonded on the surface of the ornament can be detached, the ornament protection paper bonded on the surface of the ornament bonded on the above softy bottom paper, the surface of the another ornament bonded on the surface of the ornament can be detachable, the ornament bonded on the above softy bottom layer is coated in various color.

### BRIEF DESCRIPTION OF DRAWINGS

The drawing 1 is an enlarged cross section of the bonding type accessory compositions of the old one,

The drawing 2a and 2b are an application example of the bonding type accessory that has flower type based on the invention and an enlarged A-A line cross section compositions of the above application,

The drawing 3a and 3b are an application example of the bonding type accessory that has insect type based on the invention and an enlarged A-A line cross section compositions of the above application,

The drawing 4a and 4b are an application example of the bonding type accessory that has feather type based on the invention and an enlarged A-A line cross section compositions of the above application,

The drawing 5a and 5b are an application example of the bonding type accessory that has cloth type based on the invention and an enlarged A-A line cross section compositions of the above application,

The drawing 6a and 6b are an application example of the bonding type accessory that has shoe type based on the invention and an enlarged A-A line cross section compositions of the above application,

The drawing 7 is an enlarged cross section in case of the another bonding different ornament on the surface of the bonding type accessory based on the invention

### Explanations of the Important Part of the Drawings

11.12.13.14.15.16: bonding type accessory

11a.12a.13a.14a.15a.16a.: different type paper layer

11b.12b.13b.14b.15b.16b.: bonding material layer

11c.12c.13c.14c.15c.16c: bottom layer

11d: transcribing layer

11e.12d.12e.13d.14d.15d.16d: ornament layer

13e: feather part layer

11f.12f.13f.14f: ornament protection layer

### BEST MODE FOR CARRYING OUT THE INVENTION

The explanation of the bonding type accessory, which has above properties, is the following.

The drawing 2a and 2b of the invention are an example of the invention which is flower type bonding ornament and an enlarged A-A line cross section composition, this is made by forming in order different type paper layer(11a), bonding material layer(11b), bottom layer(11c), transcribing layer of the flower type(11d), ornament layer, on which ornament made by mixing one, more than two among resin in a micro size, metal, stone material, spangle, glass are attached, and ornament protection layer(11f).

The transcribing layer (11d) of the flower type made on the surface of the above bottom layer (11c) is formed as bottom drawing before bonding ornament which is made by mixing one, more than two among resin in a micro size, metal, stone material, spangle, glass, the method of forming on the above transcribing layer is the same as usual application method.

the method of the above bonding ornament on the bottom layer is to bond by using additional bonding material, which is not hurt to body, chemical bonding material which has virus-resistant in case of the metal, stone material, glass, spangle, which have not bonding property in melting by heat. And in case of the resin, which has bonding property in melting by heat, bond them by melting and heating by pressure. It is better to use the transparent thing of the ornament only in case of making the drawing on the bottom part (11c); the reason is to represent the bottom drawing outward.

In addition, the above ornament protection layer has properties which are to prevent removing bonded ornament from the bonding ornament during moving, to prevent bonding dust on the ornament at the same time.

To use these bonding ornaments (11) on the designated spot of the clothes, body, detach the different type paper (11a) on the bottom part, after adhering bonding layer (11b) on the designated spot, detach the ornament protection layer (11f). If the bonding type accessory is bonded on the designated spot as above, it has good point which is not detached by the adhesion power on the bonding layer naturally before detaching it intentionally.

The drawing 3a and 3b of the invention are an application of the bonding ornament(12) which is insect type, the enlarged A-A line cross section of the application, this application is formed in order different type paper layer(12a), bonding material layer(12b), bottom layer(13), ornament layer(12d), on which one, more than two among resin in a micro size, metal, stone material, spangle, glass are bonded, another ornament layer(12e), on which textures of certain types on the ornament layer(12d) are bonded, and ornament protection layer.

In the other hand, by bonding additional artificial ornament(12g) on another ornament layer(12e) where the above textures are bonded it increases the effect of the ornament, the price of the products. and a certain type of the textures is a general texture, lace, gauze type.

In addition, the ornament which is made by mixing one, more than two among resin in a micro size, metal, stone material, spangle, glass, uses each of coated ornaments which has two color to represent the insect type in detail, and the method of bonding ornament on the bottom layer is to bond vegetable adhesion material which is not hurt the body, chemical bonding material which has virus-resistant, and heat by certain pressure

And, the above ornament protection layer (12f) has properties which is to prevent detaching bonded ornament (12) from the bonding ornament during moving, to prevent bonding dust on the ornament at the same time.

To bond such bonding type accessory (12) on the designated spot of the body, clothes, detach the different type paper (12a) on the bottom part, and bond the bonding material layer (12b) on the designated spot, and then detach the ornament protection layer (12f). If the bonding ornament (12) is bonded as above, it has good point which is not detached by the adhesion power of the bonding material layer naturally before detaching it intentionally.

The drawings 4a and 4b of this invention are an example of the bonding type accessory which is feather type, the enlarged A-A line cross section, and this invention is made by forming in order different type paper layer (13a), bonding material layer (13b), bottom layer (13c), ornament layer (13d) which is made by mixing and bonding one, more than two among resin in a micro size, metal, stone material, spangle, glass.

In addition, by bonding artificial ornament (artificial jewel) (13g) on the surface of the endpart of the feather (13e), the effect of the ornament increases, the high quality of the products is increased.

And, to represent the feather type clearly, the ornament, on which one, more than two among resin in a micro size, metal, stone material, spangle, glass are mixed, uses the color coated ornament which has more than two color and the above feather is coated of diverse colors. and the method of bonding the above ornament on the bottom layer, is to mix, to heat by certain pressure, to bond vegetable bonding material which is not hurt the body, chemical bonding material which has virus-resistant.

In addition, the above ornament protection layer (13f) has properties which is to prevent detaching bonding ornament (13) from the bonding type accessory during moving, to prevent bonding dust on the ornament at the same time.

The drawings 5a and 5b of this invention are an example of the bonding type accessory which is a cloth type, the enlarged A-A line cross section, and this invention is made by forming in order different type paper layer(14a, 15a), bonding material layer(14b, 15b), bottom layer(14c, 15c), ornament layer(14d, 15d) which is made by mixing and bonding one, more than two among resin in a micro size, metal, stone material, spangle, glass, ornament protection layer(14f, 15f) from the bottom.

Here, the above ornament layer(14d, 15d) is made directly on one surface of the bottom layer, the above ornament layer(14d, 15d) is to bond the other part of the textiles on the bottom layer after making the above ornament layer on the surface of the textiles. And the arrangement of the bottom layer (14c, 15c), the ornament layer made on the textiles are made of pattern types by using different ornaments.

And, the above ornament protection layer(14d, 15d) has properties which is to prevent detaching bonding ornament(14, 15) from the bonding type accessory during moving, to prevent bonding dust on the ornament at the same time.

the drawing 7 of this invention is an example which the another enlarged ornament is bonded on the surface of the bonding type accessory and a cross section, this invention is also made by forming in order different type paper layer(16a), bonding material layer(16b), bottom layer(16c), ornament layer(16d) which is made by mixing, bonding one, more than two among resin in a micro size, metal, stone material, spangle, glass, ornament protection layer(16f) from the bottom, and the different thing is that different ornament(16e), which can be detachable, is bonded on the upper part of the above ornament layer(16d).

Since the ornament of the invention as above can be bonded, detached from the spot of the cloth, body, it has a good point which can be bonded at outgoing, can be detachable at cleaning.

### INDUSTRIAL APPLICABILITY

This invention as above has bonding layer at the part of the softy bottom part which has a certain type, the other part of the above bottom part is bonded ornament on which one, more than two among resin in a micro size, metal, stone material, spangle, glass, a certain type of the textures, feather, are mixed, and by bonding it on the designated spot of the cloth, body for ornament effect, increase the convenience, the easiness at the usage.

1. An bonding type accessory, comprising, in combination: An bonding layer on the part of the softy bottom layer which has a certain type, an ornament on which one, more than two among resin in a micro size, metal, stone material, spangle, glass, a certain type of the textures, feather are mixed and bonded.

2. An bonding type accessory as defined in claim 1 including flower, tree, vegetation, animal, star map, other shape which are transcribed on the other softy bottom layer on which the above ornament is bonded.

3. A bonding type accessory as defined in claim 1 including different type paper which is bonded on the bonding layer formed at the part of the above softy bottom layer.

4. A bonding type accessory as defined in claim 1 including another different ornament which can be detached bonded on the surface of the above softy bottom layer.

5. An bonding type accessory as defined in claim 1 or claim 4 including ornament protection paper, which can be detached, bonded, on the surface of the ornament, on the surface of the another ornament which is bonded on the above ornament which is bonded on the above softy bottom paper.

6. A bonding type accessory as defined in claim 1 including bonded ornament, which is bonded on the above softy part of the bottom layer, is coated colorfully.
